(19) United States
(12) Patent Application Publication
(10) Pub. No.: US 2016/0274365 A1
(43) Pub. Date: Sep. 22, 2016

(54) SYSTEMS, DEVICES, AND METHODS FOR WEARABLE HEADS-UP DISPLAYS WITH HETEROGENEOUS DISPLAY QUALITY

(71) Applicant: THALMIC LABS INC., Kitchener (CA)

(72) Inventors: Matthew Bailey, Kitchener (CA); Stefan Alexander, Elmira (CA)

(21) Appl. No.: 15/070,887

(22) Filed: Mar. 15, 2016

Related U.S. Application Data
(60) Provisional application No. 62/134,347, filed on Mar. 17, 2015.

(51) Int. Cl. G02B 27/01; G09G 3/02; G02B 27/00

(52) U.S. Cl. CPC G02B 27/0179; G02B 27/0172; G02B 27/0093; G09G 3/02; G02B 2027/014; G02B 2027/0174; G02B 2027/0178; G02B 2027/0187

(57) ABSTRACT

Systems, devices, and methods are described for wearable heads-up displays (“WHUDs”) that provide virtual content with heterogeneous display quality. The WHUDs display virtual content with relatively high quality in a region of interest of the user's field of view (“FOV”) and with relatively lower quality in regions of the user's FOV that are outside of the region of interest. The region of interest may align with a foveal region of the user's FOV at which the user's visual acuity is maximal. By limiting display quality for peripheral regions of the virtual content at which the typical user is not able to focus, graphical processing power and/or WHUD battery power are conserved. As a result, a smaller battery and/or smaller other components may be used and the form factor of the WHUD may be reduced. A sensor may be employed to determine the region of interest in the user's FOV.

### BACKGROUND

1. Technical Field

The present systems, devices, and methods generally relate to wearable heads-up displays and particularly relate to projector-based wearable heads-up displays.

2. Description of the Related Art

### Wearable Heads-Up Displays

A head-mounted display is an electronic device that is worn on a user's head and, when so worn, secures at least one electronic display within a viewable field of at least one of the user's eyes, regardless of the position or orientation of the user's head. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. Examples of wearable heads-up displays include: the Google Glass®, the Optinvent Ora®, the Epson Moverio®, and the Sony Glasstron®, just to name a few.

The optical performance of a wearable heads-up display is an important factor in its design. When it comes to face-worn devices, however, users also care a lot about aesthetics. This is clearly highlighted by the immensity of the eyeglass (including sunglass) frame industry. Independent of their performance limitations, many of the aforementioned examples of wearable heads-up displays have struggled to find traction in consumer markets because, at least in part, they lack fashion appeal. Most wearable heads-up displays presented to date employ large display components and, as a result, most wearable heads-up displays presented to date are considerably bulkier and less stylish than conventional eyeglass frames.

A challenge in the design of wearable heads-up displays is to minimize the bulk of the face-worn apparatus will still providing displayed content with sufficient visual quality. There is a need in the art for wearable heads-up displays of more aesthetically-appealing design that are capable of providing high-quality images to the user without limiting the user's ability to see their external environment.

### BRIEF SUMMARY

A wearable heads-up display may be summarized as including: a modulative light source; a dynamic scanner; and a virtual content control system communicatively coupled to both the modulative light source and the dynamic scanner, the virtual content control system including a processor and a non-transitory processor-readable storage medium communicatively coupled to the processor, wherein the non-transitory processor-readable storage medium stores processor-executable resolution control instructions that, when executed by the processor, cause the wearable heads-up display to: identify a region of interest in the user's field of view; and project virtual content with high resolution in the region of interest and with relatively lower resolution outside of the region of interest. The wearable heads-up display may further comprise an eye-tracker communicatively coupled to the virtual content control system, wherein the processor-executable resolution control instructions, when executed by the processor, cause the wearable heads-up display to identify a region of interest in the user's field of view based on a position of the user's foveal region as determined by the eye-tracker.

A method of operating a wearable heads-up display to display virtual content with non-uniform resolution may be summarized as including: identifying a region of interest in a field of view of a user of the wearable heads-up display; and projecting, by the wearable heads-up display, virtual content with high resolution in the region of interest in the field of view of the user and with relatively lower resolution in regions of the field of view of the user that are outside of the region of interest. Identifying a region of interest in a field of view of a user of the wearable heads-up display may include identifying a foveal region in the field of view of the user of the wearable heads-up display. The wearable heads-up display may include an eye-tracker and identifying a foveal region in the field of view of the user of the wearable heads-up display may include identifying the foveal region based on a position of an eye of the user as determined by the eye-tracker.

The wearable heads-up display may comprise a modulative light source and a dynamic scanner. Projecting, by the wearable heads-up display, virtual content with high resolution in the region of interest in the field of view of the user and with relatively lower resolution in regions of the field of view of the user that are outside of the region of interest may include projecting, by the modulative light source, virtual content with a first light modulation frequency in the region of interest and with a second light modulation frequency in regions of the field of view of the user that are outside of the region of interest, wherein the first light modulation frequency is greater than the second light modulation frequency. Either in addition to or instead of such adjustments to the light modulation frequency, projecting, by the wearable heads-up display, virtual content with high resolution in the region of interest in the field of view of the user and with relatively lower resolution in regions of the field of view of the user that are outside of the region of interest may include scanning, by the dynamic scanner, virtual content with a first scanning step size in the region of interest and with a second scanning step size in regions of the field of view of the user that are outside of the region of interest, wherein the scanning step size is smaller than the second scanning step size.

A wearable heads-up display may be summarized as including: a support structure that in use is worn on a head of a user; a projector carried by the support structure; a processor communicatively coupled to the projector; and a non-transitory processor-readable storage medium communicatively coupled to the processor, wherein the non-transitory processor-readable storage medium stores processor-executable virtual content control instructions that, when executed by the processor, cause the wearable heads-up display to: determine a region of interest in a field of view of the user; project virtual content with a first quality level with respect to a first display parameter in the region of interest; and project virtual content with a second quality level with respect to the first display parameter outside of the region of interest, wherein the first quality level is higher than the second quality level. In other words, the first quality level corresponds to a “high quality” with respect to the first display parameter and the second quality level corresponds to a “relatively lower quality” with respect to the first display parameter.

The region of interest in the field of view of the user may include a foveal region of the field of view of the user. The wearable heads-up display may further include a fovea tracker carried by the support structure, positioned and oriented to determine a position of a fovea of an eye of the user, wherein the fovea tracker is communicatively coupled to the processor, and wherein the processor-executable virtual content control instructions that, when executed by the processor, cause the wearable heads-up display to determine a region of interest in a field of view of the user, cause the wearable heads-up display to determine the foveal region of the field of view of the user based on the position of the fovea of the eye of the user determined by the fovea tracker.

The wearable heads-up display may include an eye tracker carried by the support structure, positioned and oriented to determine a gaze direction of an eye of the user, wherein the eye tracker is communicatively coupled to the processor, and wherein the processor-executable virtual content control instructions that, when executed by the processor, cause the wearable heads-up display to determine a region of interest in a field of view of the user, cause the wearable heads-up display to determine a region of interest in the field of view of the user based on the gaze direction of the eye of the user determined by the eye tracker. The region of interest in the field of view of the user may include a foveal region of the field of view of the user, and the foveal region of the field of view of the user may be determined by the wearable heads-up display based on the gaze direction of the eye of the user determined by the eye tracker.

The first display parameter may be selected from a group consisting of: a resolution of virtual content projected by the projector and a brightness of virtual content projected by the projector. The projector may include at least one projector selected from a group consisting of: a scanning laser projector and a digital light processing-based projector.

The wearable heads-up display may further include a holographic combiner carried by the support structure, wherein the holographic combiner is positioned within a field of view of an eye of the user when the support structure is worn on the head of the user. The wearable heads-up display may further include a prescription eyeglass lens, wherein the holographic combiner is carried by the prescription eyeglass lens.

The support structure may have a general shape and appearance of an eyeglasses frame.

The wearable heads-up display may further include a virtual content control system, wherein both the processor and the non-transitory processor-readable storage medium are included in the virtual content control system.

A method of operating a wearable heads-up display to display virtual content with non-uniform quality, the wearable heads-up display including a projector, may be summarized as including: determining a region of interest in a field of view of a user of the wearable heads-up display; projecting, by the projector, virtual content with a first quality level with respect to a first display parameter in the region of interest of the field of view of the user; and projecting, by the projector, virtual content with a second quality level with respect to the first display parameter in regions of the field of view of the user that are outside of the region of interest, wherein the first quality level is higher than the second quality level. In other words, the first quality level corresponds to a “high quality” with respect to the first display parameter and the second quality level corresponds to a “relatively lower quality” with respect to the first display parameter.

Determining a region of interest in a field of view of a user of the wearable heads-up display may include determining a foveal region in the field of view of the user. The wearable heads-up display may include a fovea tracker and the method may further include determining a position of a fovea of an eye of the user by the fovea tracker. Determining a foveal region in the field of view of the user may include determining the foveal region of the field of view of the user based on the position of the fovea of the eye of the user determined by the fovea tracker.

The wearable heads-up display may include an eye tracker and the method may further include determining a gaze direction of an eye of the user by the eye tracker. Determining a region of interest in a field of view of a user of the wearable heads-up display may include determining the region of interest in the field of view of the user based on the gaze direction of the eye of the user determined by the eye tracker.

Projecting, by the projector, virtual content with a first quality level with respect to a first display parameter in the region of interest of the field of view of the user may include projecting, by the projector, virtual content with a first brightness level in the region of interest of the field of view of the user. Projecting, by the projector, virtual content with a second quality level with respect to the first display parameter in regions of the field of view of the user that are outside of the region of interest may include projecting, by the projector, virtual content with a second brightness level in regions of the field of view of the user that are outside of the region of interest, wherein the first brightness level is brighter than the second brightness level.

Projecting, by the projector, virtual content with a first quality level with respect to a first display parameter in the region of interest of the field of view of the user may include projecting, by the projector, virtual content with a first resolution in the region of interest of the field of view of the user. Projecting, by the projector, virtual content with a second quality level with respect to the first display parameter in regions of the field of view of the user that are outside of the region of interest may include projecting, by the projector, virtual content with a second resolution in regions of the field of view of the user that are outside of the region of interest, wherein the first resolution is a higher resolution than the second resolution. Projecting, by the projector, virtual content with a first resolution in the region of interest of the field of view of the user may include projecting, by the projector, virtual content with a first light modulation frequency in the region of interest of the field of view of the user; and projecting, by the projector, virtual content with a second resolution in regions of the field of view of the user that are outside of the region of interest may include projecting, by the projector, virtual content with a second light modulation frequency in regions of the field of view of the user that are outside of the region of interest, wherein the first light modulation frequency is greater than the second light modulation frequency. Either alternatively or in addition, projecting, by the projector, virtual content with a first resolution in the region of interest of the field of view of the user may include scanning, by the projector, virtual content with a first scanning step size in the region of interest of the field of view of the user; and projecting, by the projector, virtual content with a second resolution in regions of the field of view of the user that are outside of the region of interest may include projecting, by the projector, virtual content with a second scanning step size in regions of the field of view of the user that are outside of the region of interest, wherein the first scanning step size is smaller than the second scanning step size.

The wearable heads-up display may include a processor and a non-transitory processor-readable storage medium communicatively coupled to the processor and which stores processor-executable virtual content control instructions. In this case: determining a region of interest in a field of view of a user of the wearable heads-up display may include executing the processor-executable virtual content control instructions by the processor to cause the wearable heads-up display to determine the region of interest in the field of view of the user; projecting, by the projector, virtual content with a first quality level with respect to a first display parameter in the region of interest of the field of view of the user may include executing the processor-executable virtual content control instructions by the processor to cause the projector to project virtual content with the first quality level with respect to the first display parameter in the region of interest of the field of view of the user; and projecting, by the projector, virtual content with a second quality level with respect to the first display parameter in regions of the field of view of the user that are outside of the region of interest may include executing the processor-executable virtual content control instructions by the processor to cause the projector to project virtual content with the second quality level with respect to the first display parameter in regions of the field of view of the user that are outside of the region of interest.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a partial-cutaway perspective view of a wearable heads-up display that provides heterogeneous display quality with respect to at least one display parameter in accordance with the present systems, devices, and methods.

FIG. 2 is an illustrative diagram showing a plan view of exemplary projected virtual content from a wearable heads-up display that employs heterogeneous (non-uniform) display quality in accordance with the present systems, devices, and methods.

FIG. 3 is a flow-diagram showing a method of operating a wearable heads-up display to display virtual content with heterogeneous (non-uniform) quality in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments described herein provide systems, devices, and methods for wearable heads-up displays (“WHUDs”) with heterogeneous or non-uniform display quality. Such heterogeneous or non-uniform display quality can advantageously reduce the graphical processing power and/or overall power consumption of a WHUD without compromising the perceived quality of the displayed content (i.e., “virtual content”). Relative to implementations having higher graphical processing power and/or higher overall power consumption, reducing the graphical processing power and/or overall power consumption of the WHUD in accordance with the present systems, devices, and methods enables the WHUD to employ smaller components (e.g., a smaller processor, a smaller memory, a smaller battery or batteries, and/or a smaller cooling system), which in turn enables the WHUD to adopt a smaller form factor and an overall more pleasing aesthetic design.

The perceived quality of virtual content displayed by a WHUD may depend on a number of display parameters, including without limitation: resolution, number of pixels, pixel density, pixel size, brightness, color saturation, sharpness, focus, noise, and so on. All other things being equal, a WHUD that displays virtual content with high quality may generally demand higher graphical processing power and/or generally consume more overall power than a WHUD that displays virtual content with relatively lower image quality. As described above, higher graphical processing power and/or higher overall power consumption can add significant and unwanted bulk to a WHUD by necessitating, for example, larger battery(ies), a larger processor, a larger memory coupled to the processor, a larger display engine, and/or a larger cooling system for the processor and/or for the display engine. The present systems, devices, and methods describe WHUDs that strategically display virtual content with heterogeneous or non-uniform display quality (with respect to at least one display parameter) in order to provide virtual content that still appears in high quality to the user without necessitating all, as many, or any larger or more powerful components. In this way, the added bulk of the WHUD is limited and a more aesthetically-pleasing design is realized.

Throughout this specification and the appended claims, a “projector-based” WHUD is generally used as an example of a WHUD architecture; however, a person of skill in the art will appreciate that the various teachings described herein may be applied in other, non-projector-based WHUD architectures (e.g., WHUD architectures that employ one or more microdisplay(s) and/or waveguide structures). Generally, a projector-based WHUD may be a form of virtual retina display in which a projector draws a raster scan onto the eye of the user. The projector may include a scanning laser projector, a digital light processing-based projector, or generally any combination of a modulative light source (such as a laser or one or more LED(s)) and a dynamic reflector mechanism (such as one or more dynamic scanner(s) or digital light processor(s)). In the absence of any further measure the projector may project light over a fixed area called the field of view (“FOV”) of the display.

FOV generally refers to the extent that a scene is visible to an observer and is usually characterized by the angle formed at the eye between respective light beams originating from two points at opposite edges of a scene that are both visible from the same eye position. The human eye typically has a FOV of almost 180° across the horizontal direction and about 135° across the vertical direction. A WHUD typically has a FOV that is less than the FOV of the eye, although it is desirable for a WHUD to be capable of providing virtual content with a FOV as close as possible to the FOV of the eye. Unfortunately, this is typically a great challenge given the close proximity of the WHUD to the eye. Furthermore, providing images with the full 180°×135° FOV can be very demanding of the display architecture, at least in terms of graphical processing power and overall power consumption. In conventional WHUD implementations and with all other things being equal, a larger FOV demands more graphical processing power because a larger FOV generally means there is more virtual content to display. Likewise, in conventional WHUD implementations and with all other things being equal, a larger FOV has overall higher power consumption because, at least in part, of the higher levels of graphical processing and the overall increased light signal generation necessary to fill the larger FOV. Even if a WHUD architecture is capable of accommodating such graphical processing and power consumption, doing so can add significant and unwanted bulk in the form of, for example, larger battery(ies), a larger processor, a larger memory coupled to the processor, a larger projector and/or larger projector components, and/or a larger cooling system for the processor and/or for the projector. Accordingly, the various embodiments described herein include techniques for projecting virtual content with a high FOV while easing the demands (e.g., graphical processing demands and/or power consumption) on the display architecture. This is achieved, at least in part, by projecting virtual content with heterogeneous or non-uniform display quality with respect to at least one display parameter. For example, virtual content may be projected with heterogeneous or non-uniform resolution and/or with heterogeneous or non-uniform brightness. In particular, the virtual content may be projected with relatively high quality with respect to a first display parameter (e.g., resolution or brightness) at and over a particular region of interest/focus and with relatively lower quality with respect to the same first display parameter elsewhere. By concentrating the display quality in a specific region (or in specific regions) of the full displayed FOV, a large FOV may be displayed to the user while mitigating demands on graphical processing and power. This scheme advantageously accounts for the fact that a user's ability to focus is typically not uniform over the eye's entire FOV. In practice, when a user is focusing on a high quality region of interest in a complete FOV, the user may not be able to detect that regions of the FOV that are outside of this region of interest are being projected at lower quality.

Throughout this specification, the terms “high quality” and “low quality”, as well as variants such as “higher quality” and “lower quality” are often used with respect to one or more display parameter(s). Unless the specific context requires otherwise, such terms are generally used in a relative sense with respect to the same display parameter. “High quality” (and its variants) generally refers to a first quality level with respect to a first display parameter, the first quality level generally equal to the perceived quality of the WHUD with respect to the first display parameter. “Low quality” (and its variants) generally refers to a second quality level with respect to the same first display parameter, the second quality level generally lower than and/or less than the first quality level. The terms “high quality” and “low quality” are used to denote that the first quality level is higher than the second quality level with respect to the same display parameter. The exact amount by which a “high quality” is higher than a “low quality” may depend on a variety of factors, including the specific display parameter and/or other display parameters in the WHUD. For example, a first quality level or “high quality” with respect to a display parameter may be 1% higher than a second quality level or “low quality” with respect to the same display parameter, a first quality level or “high quality” with respect to a display parameter may be 10% higher than a second quality level or “low quality” with respect to the same display parameter, a first quality level or “high quality” with respect to a display parameter may be 25% higher than a second quality level or “low quality” with respect to the same display parameter, a first quality level or “high quality” with respect to a display parameter may be 50% higher than a second quality level or “low quality” with respect to the same display parameter, a first quality level or “high quality” with respect to a display parameter may be 100% higher than a second quality level or “low quality” with respect to the same display parameter, or a first quality level or “high quality” with respect to a display parameter may be more than 100% higher than a second quality level or “low quality” (e.g., 150%, 200%, and so on) with respect to the same display parameter. A first quality level being higher than a second quality level may correspond to the actual value of the first quality level being greater than or less than the second quality level depending on the specific display parameter. For example, if the display parameter in question is pixel density, then in order for the first quality level to be higher than the second quality level the pixel density associated with the first quality level may be greater than the pixel density associated with the second quality level; however, if the display parameter in question is the spacing in between pixels, then in order for the first quality level to be higher than the second quality level the spacing in between pixels associated with the first quality level may be less than the spacing in between pixels associated with the second quality level.

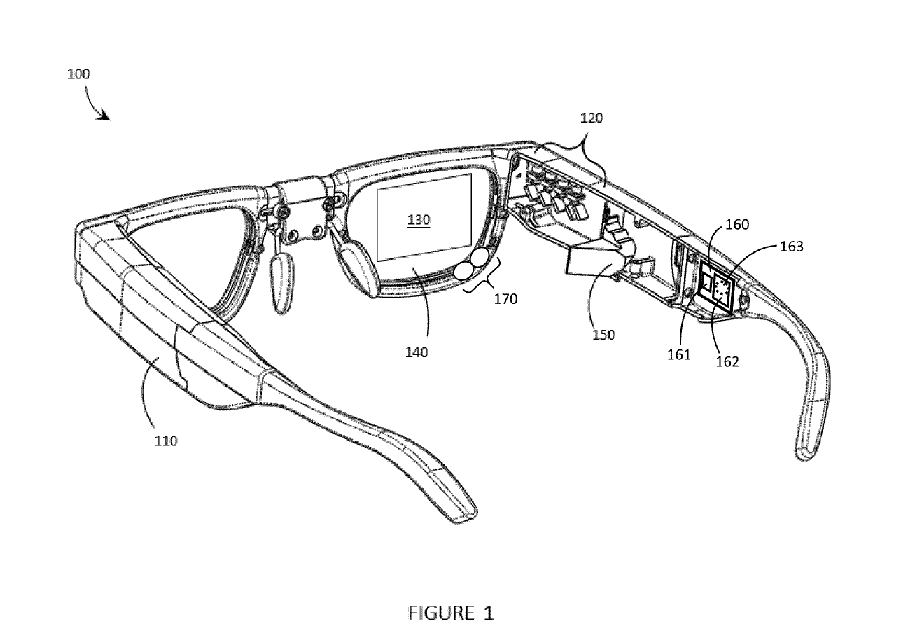

FIG. 1 is a partial-cutaway perspective view of a WHUD 100 that provides heterogeneous display quality with respect to at least one display parameter in accordance with the present systems, devices, and methods. WHUD 100 includes a support structure 110 that in use is worn on the head of a user and has a general shape and appearance of an eyeglasses (e.g., sunglasses) frame. Support structure 110 carries multiple components, including: a projector 120 (a scanning laser projector in the illustrated example), a holographic combiner 130, and an exit pupil expansion optic 150. Portions of projector 120 and exit pupil expansion optic 150 may be contained within an inner volume of support structure 110; however, FIG. 1 provides a partial-cutaway view in which regions of support structure 110 have been removed in order to render visible portions of projector 120 and exit pupil expansion optic 150 that may otherwise be concealed. In accordance with the present systems, devices, and methods, support structure 110 also carries a virtual content control system 160 communicatively coupled to projector 120. Virtual content control system 160 comprises a processor 161 and a non-transitory processor-readable storage medium or memory 162 communicatively coupled to the processor 162. Memory 162 stores processor-executable virtual content control data and/or instructions 163 that, when executed by processor 161, cause WHUD 100 to provide heterogeneous display quality with respect to at least one display parameter as discussed in more detail later on.

Throughout this specification and the appended claims, the term “carries” and variants such as “carried by” are generally used to refer to a physical coupling between two objects. The physical coupling may be direct physical coupling (i.e., with direct physical contact between the two objects) or indirect physical coupling that may be mediated by one or more additional objects. Thus, the term carries and variants such as “carried by” are meant to generally encompass all manner of direct and indirect physical coupling, including without limitation: carried on, carried within, physically coupled to, and/or supported by, with or without any number of intermediary physical objects therebetween.

Projector 120 is a scanning laser projector, though as previously described other forms of projectors may similarly be used, such as a digital light processing-based projector. Projector 120 includes multiple laser diodes (e.g., a red laser diode, a green laser diode, and/or a blue laser diode) and at least one scan mirror (e.g., a single two-dimensional scan mirror or two one-dimensional scan mirrors, which may be, e.g., MEMS-based or piezo-based). As previously described, a person of skill in the art will appreciate that the teachings herein may be applied in WHUDs that employ non-projector-based display architectures, such as WHUDs that employ microdisplays and/or waveguide structures.

Holographic combiner 130 is positioned within a field of view of at least one eye of the user when support structure 110 is worn on the head of the user. Holographic combiner 130 is sufficiently optically transparent to permit light from the user's environment (i.e., “environmental light”) to pass through to the user's eye. In the illustrated example of FIG. 1, support structure 110 further carries a transparent eyeglass lens 140 (e.g., a prescription eyeglass lens) and holographic combiner 130 comprises at least one layer of holographic material that is adhered to, affixed to, laminated with, carried in or upon, or otherwise integrated with eyeglass lens 140. The at least one layer of holographic material may include a photopolymer film such as Bayfol®HX available from Bayer MaterialScience AG or a silver halide compound and may, for example, be integrated with transparent lens 140 using any of the techniques described in U.S. Provisional Patent Application Ser. No. 62/214,600. Holographic combiner 130 includes at least one hologram in or on the at least one layer of holographic material. With holographic combiner 130 positioned in a field of view of an eye of the user when support structure 110 is worn on the head of the user, the at least one hologram of holographic combiner 130 is positioned and oriented to redirect light originating from projector 120 towards the eye of the user. In particular, the at least one hologram is positioned and oriented to receive light signals that originate from projector 120 and converge those light signals to at least one exit pupil at or proximate the eye of the user.

Exit pupil expansion optic 150 is positioned in an optical path between projector 120 and holographic combiner 130 and may take on any of a variety of different forms, including without limitation those described in U.S. patent application Ser. No. 15/046,234, U.S. patent application Ser. No. 15/046,254, and/or U.S. patent application Ser. No. 15/046,269.

In accordance with the present systems, devices, and methods, the processor-executable virtual content control instructions (and/or data) 163, when executed by processor 161 of virtual content control system, cause WHUD 100 to provide heterogeneous display quality with respect to at least one display parameter. Specifically, when executed by processor 161, processor-executable virtual content control instruction (and/or data) 163 cause WHUD 100 to determine a region of interest in a FOV of the user, project virtual content with a high quality with respect to a first display parameter in the region of interest, and project virtual content with a relatively lower quality with respect to the first display parameter outside of the region of interest. As previously described, the first display parameter may include any of a variety of different display parameters depending on the specific implementation, including without limitation: resolution, number of pixels, pixel density, pixel size, brightness, color saturation, sharpness, focus, and/or noise. In some implementations, the WHUD (100) may provide heterogeneous (non-uniform) display quality with respect to multiple different display parameters, such as at least two different display parameters.

Throughout this specification and the appended claims the term “resolution” is used, with reference to display quality and/or virtual content projected by a projector (1200, to generally refer to a distribution of pixels or lines that make up a display and/or that make up virtual content of a display. In accordance with the present systems, devices, and methods, the “quality” of resolution may depend on a number of resolution parameters and, accordingly, the quality of resolution may be adjusted (i.e., made higher or lower) by tuning any one or combination of multiple ones of the resolution parameters. Exemplary resolution parameters that may be tuned in order to make the display quality of virtual content higher or lower with respect to display resolution include, without limitation: number of pixels, size of pixels, spacing in between pixels, and/or pixel density. For example, the display quality of WHUD 100 may be made higher with respect to resolution by increasing the number of pixels, decreasing the size of pixels, and/or increasing the pixel density. Conversely, the display quality of WHUD 100 may be made lower with respect to resolution by decreasing the number of pixels, increasing the size of pixels, and/or decreasing the pixel density.

Resolution is just one example of a display parameter that may be varied of the FOV of a WHUD to provide heterogeneous (non-uniform) display quality in accordance with the present systems, devices, and methods. Brightness is another example of such a display parameter. For example, the display quality of WHUD 100 may be made higher with respect to brightness by increasing the brightness and the display quality of WHUD 100 may be made lower with respect to brightness by decreasing the brightness.

In some implementations, providing heterogeneous (non-uniform) display quality with respect to a first display parameter may include heterogeneously varying at least a second display parameter over the FOV of a WHUD in order to compensate for one or more effect(s) of providing heterogeneous display quality with respect to the first display parameter. For example, regions of a WHUD's FOV that are displayed with relatively low quality resolution may be displayed with relatively higher brightness to compensate and reduce the likelihood that the user will perceive the non-uniformity in resolution.

The region of interest in the FOV of the user in which virtual content is displayed (e.g., projected) with high quality with respect to a first display parameter may be determined (e.g., identified, deduced, or defined) in a variety of different ways. In some implementations, the region of interest may be an attribute of the virtual content itself and correspond to a region of the virtual content where the user is expected to attract their attention based on the nature of the virtual content. For example, if the virtual content comprises a block of text overlaid on a textured background, virtual content control system 160 may determine (e.g., define or deduce) that the region of interest corresponds to the block of text as this is likely where the user will direct their attention. In some implementations, virtual content control system 160 may define a region of interest in order to strategically direct the user's attention (e.g., guide the user's gaze) to that region of the virtual content, for example, to highlight a new alert or notification and draw the user's attention thereto or to highlight a particular position on a map.

In other implementations, the region of interest may be identified by the WHUD (100) based on one or more property(ies) of the user's eye. For example, WHUD 100 includes a sensor 170 carried by support structure 110, where sensor 170 is operative to sense, measure, detect, monitor, and/or track one or more property(ies) of the user's eye. Sensor 170 is communicatively coupled to virtual content control system 160 and data from sensor 170 that is indicative or representative of one or more property(ies) of the user's eye may be used by virtual content control system 160 to determine a region of interest in a FOV of the user. Two exemplary eye properties that may be sensed, measured, detected, monitored, and/or tracked by sensor 170 and used by virtual content control system 160 to determine a region of interest in the user's FOV are now described.

In a first example, the region of interest in the FOV of the user may include a foveal region of the FOV of the user. A person of skill in the art will appreciate that the foveal region in the FOV of the user may generally correspond to light rays that impinge on the fovea (i.e., the “fovea centralis”) on the retina of the user's eye. The fovea is a depression in the inner surface of the retina (usually about 1.5 mm wide) that includes a relatively higher density of cone cells compared to the rest of the retinal surface. Due to this high density of cone cells, the fovea is generally the region of the retina that provides the sharpest (e.g., most detailed) vision and/or the highest visual acuity. When viewing an object or particularly fine detail, such as when reading text, humans have generally evolved to direct their gaze (e.g., adjust their eye position) so that light coming from the detailed object impinges on the fovea.

In this first example, WHUD 100 projects virtual content with high quality (with respect to a first display parameter) in the foveal region of the user's FOV by aligning the virtual content with the user's eye so that the high quality region of the virtual content aligns with (e.g., impinges on) the fovea of the retina of the user's eye. In order to determine the position of the fovea of the user's eye, sensor 170 may include a fovea tracker that is communicatively coupled to virtual content control system 160 (e.g., communicatively coupled to processor 161 of virtual content control system 160). Fovea tracker 170 is positioned and oriented to determine a position of the fovea of the user's eye and processor-executable virtual content control instructions 163 may, when executed by processor 161, cause WHUD 100 to determine (e.g., identify) the foveal region of the user's FOV based on the position of the fovea of the user's eye determined by fovea tracker 170.

Depending on the specific implementation, fovea tracker 170 may employ a variety of different techniques. As an example, fovea tracker 170 may comprise an illumination source (e.g., a light source, such as an infrared light source) and/or an optical sensor such as a camera, a video camera, or a photodetector. With the eye sufficiently illuminated (e.g., by an illumination source component of fovea tracker 170), the optical sensor component of fovea tracker 170 may sense, detect, measure, monitor, and/or track retinal blood vessels and/or other features on the inside of the user's eye from which the position of the fovea may be determined (e.g., identified). More specifically, the optical sensor component of fovea tracker 170 may capture images of the user's eye and a processor communicatively coupled to the optical sensor (e.g., processor 161) may process the images to determine (e.g., identify) the position of the fovea based on, for example, discernible features of the retina (e.g., retinal blood vessels) in the images. Processing the mages by the processor may include executing, by the processor, processor-readable image processing data and/or instructions stored in a non-transitory processor-readable storage medium or memory (e.g., memory 162) of WHUD 100.

In a second example, the region of interest in the FOV of the user may be determined by WHUD 100 based on the gaze direction of the user. To this end, sensor 170 may include an eye tracker carried by support structure 110 and positioned and oriented to determine a gaze direction of the eye of the user. Eye tracker 170 may be communicatively coupled to virtual content control system 160 (e.g., communicatively coupled to processor 161 of virtual content control system 160) and processor-executable virtual content control instructions 163 may, when executed by processor 161, cause WHUD 100 to determine (e.g., identify) a region of interest in the FOV of the user based on the gaze direction of the user's eye determined by eye tracker 170.

A person of skill in the art will appreciate that in different implementations, eye tracker 170 itself may determine the gaze direction of the user's eye and relay this information to processor 161, or processor 161 may determine the gaze direction of the user's eye based on data and/or information provided by eye tracker 170.

Eye tracker 170 may employ any of a variety of different eye tracking technologies depending on the specific implementation. For example, eye tracker 170 may employ any or all of the systems, devices, and methods described in U.S. Provisional Patent Application Ser. No. 62/167,767; U.S. Provisional Patent Application Ser. No. 62/271,135; U.S. Provisional Patent Application Ser. No. 62/245,792; and/or U.S. Provisional Patent Application Ser. No. 62/281,041.

Based on data and/or information about the gaze direction of the user's eye, virtual content control system 160 may position the region of interest to align with the gaze direction of the user's eye so that the region of interest appears substantially centrally in the user's FOV and remains in this position for all eye positions over a wide range of eye positions. This approach may cause the region of interest to at least partially align with the foveal region in the user's FOV without direct determination of the position of the user's fovea. However, in some implementations the position of the fovea in the user's eye (and the corresponding position of the foveal region in the user's FOV) may be determined (e.g., deduced) by virtual content control system 160 based on the gaze direction of the user's eye because the position of the fovea in the user's eye is generally fixed relative to the positions of the pupil, iris, cornea, and/or other features of the user's eye that may be sensed, measured, detected, monitored, and/or tracked by eye tracker 170 in determining the gaze direction of the user's eye.

In some implementations of the present systems, devices, and methods, virtual content is dynamically projected with highest quality (with respect to at least one display parameter) in the region of the user's FOV that corresponds to the user's fovea (e.g., the foveal region of the user's FOV) and with relatively lower quality (with respect to the same at least one display parameter) elsewhere in the user's FOV (i.e., in regions of the user's FOV outside of the foveal region). The virtual content is “dynamic” in the sense that the high quality region “follows” the user's fovea (i.e., follows the foveal region in the user's FOV) based on the user's fovea position, eye position, and/or gaze direction as determined by sensor 170. Since the user's ability to focus over the entire FOV is non-uniform, it is unnecessary to project (and to provide sufficient infrastructure, e.g., graphical processing power and overall system power to render the system capable of projecting) virtual content with high quality over the entire FOV. Rather, in accordance with the present systems, devices, and methods, only the foveal region (or another region of interest) of the virtual content may be projected at high quality while the peripheral region(s) of the virtual content may be projected at comparatively lower quality.

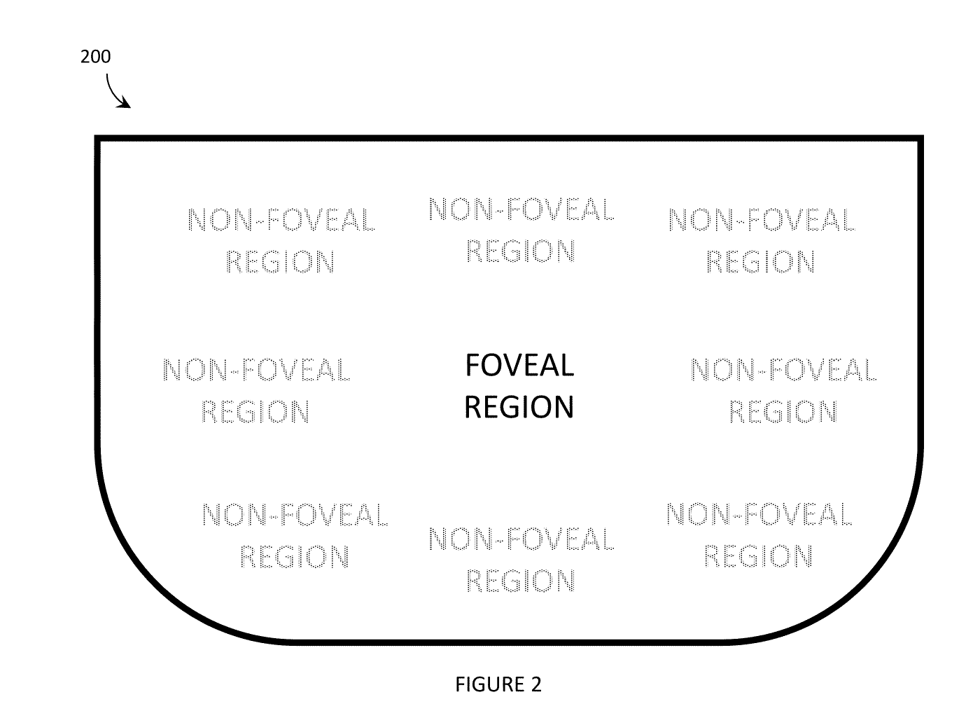

FIG. 2 is an illustrative diagram showing a plan view of exemplary projected virtual content from a WHUD 200 that employs heterogeneous (non-uniform) display quality in accordance with the present systems, devices, and methods. In the illustrated example, virtual content corresponding to the “foveal region” of the user's FOV (as determined by an on-board fovea-tracking system and/or an on-board eye-tracking system, not illustrated in FIG. 2 to reduce clutter) is depicted with greater clarity (i.e., sharper focus, higher resolution, and/or higher brightness) compared to regions of the user's FOV that are outside of the foveal region (i.e., non-foveal regions) in order to illustrate that the foveal region has higher display quality than the non-foveal regions.

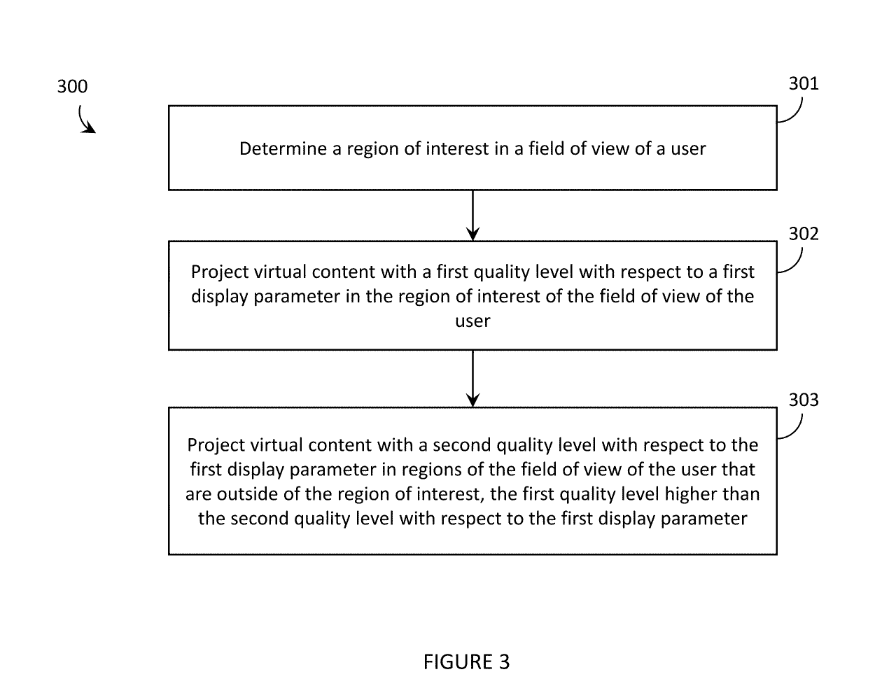

FIG. 3 is a flow-diagram showing a method 300 of operating a WHUD to display virtual content with heterogeneous (non-uniform) quality in accordance with the present systems, devices, and methods. The WHUD includes a projector and may be substantially similar to WHUD 100 from FIG. 1. Method 300 includes three acts 301, 302, and 303, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments. For the purposes of method 33, the term “user” refers to a person that is wearing the WHUD.

At 301, a region of interest in the user's FOV is determined. This region of interest may be determined by the WHUD itself, for example, by the processor of a virtual content control system carried by the WHUD. In some implementations, this region of interest may be determined (e.g., defined) by (i.e., within) a software application executed by a processor on-board the WHUD based on an intention to motivate the user to focus on this particular region. In alternative implementations, this region of interest may be determined (e.g., identified or deduced) by the WHUD based on data and/or information provided by one or more sensor(s) (such as a fovea tracker and/or and eye tracker) based on the position of the fovea of the user's eye, the position of the user's eye, and/or the gaze direction of the user's eye. The region of interest may or may not include a foveal region of the user's FOV.

At 302, the projector of the WHUD projects virtual content with a high quality with respect to a first display parameter in the region of interest in the FOV of the user.

At 303, the projector of the WHUD projects virtual content with a relatively lower quality with respect to the first display parameter in regions of the field of view of the user that are outside of the region of interest.

As previously described, the first display parameter may include any of a variety of different display parameters depending on the specific implementation, including without limitation: resolution, number of pixels, pixel density, pixel size, brightness, color saturation, sharpness, focus, and/or noise. As an example, at 302 the projector of the WHUD may project virtual content with a high brightness in the region of interest of the FOV of the user and at 303 the projector may project virtual content with a relatively lower brightness in regions of the FOV of the user that are outside of the region of interest. As another example, at 302 the projector of the WHUD may project virtual content with a high resolution in the region of interest of the FOV of the user and at 303 the projector may project virtual content with a relatively lower resolution in regions of the FOV of the user that are outside of the region of interest.

As also previously described, the quality of the resolution of the virtual content may be varied in a number of different ways, especially when a projector is used in the display system of the WHUD. In some cases, the quality of the resolution may be varied by adjusting the number pixels in the virtual content, the size of the pixels in the virtual content, the size of the gaps between pixels in the virtual content, and/or the density of pixels in the virtual content. In a projector-based WHUD, the quality of the resolution of virtual content may be varied by adjusting either or both of the light modulation of the modulative light source (e.g., laser diodes, LEDs, or similar) and/or the operation of the one or more dynamically-variable reflector(s) (e.g., scan mirror(s)).

As a first example, at 302 the projector may project virtual content with a high resolution in the region of interest of the FOV of the user by projecting virtual content with a first light modulation frequency in the region of interest in the FOV of the user and at 303 the projector may project virtual content with a relatively lower resolution in regions of the FOV of the user that are outside of the region of interest by projecting virtual content with a second light modulation frequency in regions of the FOV of the user that are outside of the region of interest. In this case, the first light modulation frequency is greater than the second light modulation frequency.

As a second example, at 302 the projector (e.g., a scanning laser projector) may project virtual content with a high resolution in the region of interest of the FOV of the user by scanning virtual content with a first scanning step size in the region of interest in the FOV of the user and at 303 the projector may project virtual content with a relatively lower resolution in regions of the FOV of the user that are outside of the region of interest by scanning virtual content with a second scanning step size in regions of the FOV of the user that are outside of the region of interest. In this case, the first scanning step size is smaller than the second scanning step size.

In general, using a scanning laser projector heterogeneous (non-uniform) display resolution may be achieved by operating either or both of the modulative light source and/or the dynamic scanner to project relatively fewer/larger pixels outside of the user's foveal region and relatively more/smaller pixels within the user's foveal region. The result may be more concentrated image detail (i.e., a higher number/concentration of distinct pixels) in the user's foveal region (as dynamically determined by the eye-tracker(s)) and reduced image detail (i.e., a lower number/concentration of distinct pixels) outside of the user's foveal region. The discrepancy is pixel concentration may significantly save on graphical processing and power consumption while nevertheless remaining substantially undetectable to the user, because the user typically cannot focus to high degrees of resolution on those regions of their field of view that are outside of the foveal region.

The WHUDs described herein may include one or more on-board power sources (e.g., one or more battery(ies)), a wireless transceiver for sending/receiving wireless communications, and/or a tethered connector port for coupling to a computer and/or charging the one or more on-board power source(s).

The WHUDs described herein may receive and respond to commands from the user in one or more of a variety of ways, including without limitation: voice commands through a microphone; touch commands through buttons, switches, or a touch sensitive surface; and/or gesture-based commands through gesture detection systems as described in, for example, U.S. Non-Provisional patent application Ser. No. 14/155,087, U.S. Non-Provisional patent application Ser. No. 14/155,107, PCT Patent Application PCT/US2014/057029, and/or U.S. Provisional Patent Application Ser. No. 62/236,060, all of which are incorporated by reference herein in their entirety.

The various implementations of WHUDs described herein may include any or all of the technologies described in U.S. Provisional Patent Application Ser. No. 62/156,736, and/or U.S. Provisional Patent Application Ser. No. 62/242,844.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” “to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: U.S. Provisional Patent Application Ser. No. 62/134,347; U.S. Provisional Patent Application Ser. No. 62/214,600, U.S. Provisional Patent Application Ser. No. 62/268,892, U.S. Provisional Patent Application Ser. No. 62/167,767, U.S. Provisional Patent Application Ser. No. 62/271,135, U.S. Provisional Patent Application Ser. No. 62/245,792, U.S. Provisional Patent Application Ser. No. 62/281,041, U.S. Provisional Patent Application Ser. No. 62/288,947, U.S. Non-Provisional patent application Ser. No. 14/155,087, U.S. Non-Provisional patent application Ser. No. 14/155,107, PCT Patent Application PCT/US2014/057029, U.S. Provisional Patent Application Ser. No. 62/236,060, U.S. Provisional Patent Application Ser. No. 62/156,736, U.S. Non-Provisional patent application Ser. No. 15/046,254, U.S. Non-Provisional patent application Ser. No. 15/046,234, U.S. Non-Provisional patent application Ser. No. 15/046,269, and U.S. Provisional Patent Application Ser. No. 62/242,844, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable heads-up display comprising:
a support structure that in use is worn on a head of a user;
a projector carried by the support structure;
a processor communicatively coupled to the projector; and
a non-transitory processor-readable storage medium communicatively coupled to the processor, wherein the non-transitory processor-readable storage medium stores processor-executable virtual content control instructions that, when executed by the processor, cause the wearable heads-up display to:
determine a region of interest in a field of view of the user;
project virtual content with a first quality level with respect to a first display parameter in the region of interest; and
project virtual content with a second quality level with respect to the first display parameter outside of the region of interest, wherein the first quality level is higher than the second quality level.

2. The wearable heads-up display of claim 1 wherein the region of interest in the field of view of the user includes a foveal region of the field of view of the user.

3. The wearable heads-up display of claim 2, further comprising:
a fovea tracker carried by the support structure, positioned and oriented to determine a position of a fovea of an eye of the user, wherein the fovea tracker is communicatively coupled to the processor, and wherein the processor-executable virtual content control instructions that, when executed by the processor, cause the wearable heads-up display to determine a region of interest in a field of view of the user, cause the wearable heads-up display to determine the foveal region of the field of view of the user based on the position of the fovea of the eye of the user determined by the fovea tracker.

4. The wearable heads-up display of claim 1, further comprising:
an eye tracker carried by the support structure, positioned and oriented to determine a gaze direction of an eye of the user, wherein the eye tracker is communicatively coupled to the processor, and wherein the processor-executable virtual content control instructions that, when executed by the processor, cause the wearable heads-up display to determine a region of interest in a field of view of the user, cause the wearable heads-up display to determine a region of interest in the field of view of the user based on the gaze direction of the eye of the user determined by the eye tracker.

5. The wearable heads-up display of claim 4 wherein the region of interest in the field of view of the user includes a foveal region of the field of view of the user, and wherein the foveal region of the field of view of the user is determined by the wearable heads-up display based on the gaze direction of the eye of the user determined by the eye tracker.

6. The wearable heads-up display of claim 1 wherein the first display parameter is selected from a group consisting of: a resolution of virtual content projected by the projector and a brightness of virtual content projected by the projector.

7. The wearable heads-up display of claim 1 wherein the projector includes at least one projector selected from a group consisting of: a scanning laser projector and a digital light processing-based projector.

8. The wearable heads-up display of claim 1, further comprising:
a holographic combiner carried by the support structure, wherein the holographic combiner is positioned within a field of view of an eye of the user when the support structure is worn on the head of the user.

9. The wearable heads-up display of claim 8, further comprising:
a prescription eyeglass lens, wherein the holographic combiner is carried by the prescription eyeglass lens.

10. The wearable heads-up display of claim 1 wherein the support structure has a general shape and appearance of an eyeglasses frame.

11. The wearable heads-up display of claim 1, further comprising:
a virtual content control system, wherein both the processor and the non-transitory processor-readable storage medium are included in the virtual content control system.

12. A method of operating a wearable heads-up display to display virtual content with non-uniform quality, the wearable heads-up display including a projector and the method comprising:
determining a region of interest in a field of view of a user of the wearable heads-up display;
projecting, by the projector, virtual content with a first quality level with respect to a first display parameter in the region of interest of the field of view of the user; and
projecting, by the projector, virtual content with a second quality level with respect to the first display parameter in regions of the field of view of the user that are outside of the region of interest, wherein the first quality level is higher than the second quality level.

13. The method of claim 12 wherein determining a region of interest in a field of view of a user of the wearable heads-up display includes determining a foveal region in the field of view of the user.

14. The method of claim 13 wherein the wearable heads-up display includes a fovea tracker and the method further comprises:
determining a position of a fovea of an eye of the user by the fovea tracker, and wherein determining a foveal region in the field of view of the user includes determining the foveal region of the field of view of the user based on the position of the fovea of the eye of the user determined by the fovea tracker.

15. The method of claim 12 wherein the wearable heads-up display includes an eye tracker and the method further comprises:
determining a gaze direction of an eye of the user by the eye tracker, and wherein determining a region of interest in a field of view of a user of the wearable heads-up display includes determining the region of interest in the field of view of the user based on the gaze direction of the eye of the user determined by the eye tracker.

16. The method of claim 12 wherein:
projecting, by the projector, virtual content with a first quality level with respect to a first display parameter in the region of interest of the field of view of the user includes projecting, by the projector, virtual content with a first brightness level in the region of interest of the field of view of the user; and
projecting, by the projector, virtual content with a second quality level with respect to the first display parameter in regions of the field of view of the user that are outside of the region of interest includes projecting, by the projector, virtual content with a second brightness level in regions of the field of view of the user that are outside of the region of interest, wherein the first brightness level is brighter than the second brightness level.

17. The method of claim 12 wherein:
projecting, by the projector, virtual content with a first quality level with respect to a first display parameter in the region of interest of the field of view of the user includes projecting, by the projector, virtual content with a first resolution in the region of interest of the field of view of the user; and
projecting, by the projector, virtual content with a second quality level with respect to the first display parameter in regions of the field of view of the user that are outside of the region of interest includes projecting, by the projector, virtual content with a second resolution in regions of the field of view of the user that are outside of the region of interest, wherein the first resolution is a higher resolution than the second resolution.

18. The method of claim 17 wherein:
projecting, by the projector, virtual content with a first resolution in the region of interest of the field of view of the user includes projecting, by the projector, virtual content with a first light modulation frequency in the region of interest of the field of view of the user; and
projecting, by the projector, virtual content with a second resolution in regions of the field of view of the user that are outside of the region of interest includes projecting, by the projector, virtual content with a second light modulation frequency in regions of the field of view of the user that are outside of the region of interest, wherein the first light modulation frequency is greater than the second light modulation frequency.

19. The method of claim 17 wherein:
projecting, by the projector, virtual content with a first resolution in the region of interest of the field of view of the user includes scanning, by the projector, virtual content with a first scanning step size in the region of interest of the field of view of the user; and
projecting, by the projector, virtual content with a second resolution in regions of the field of view of the user that are outside of the region of interest includes projecting, by the projector, virtual content with a second scanning step size in regions of the field of view of the user that are outside of the region of interest, wherein the first scanning step size is smaller than the second scanning step size.

20. The method of claim 12 wherein the wearable heads-up display includes a processor and a non-transitory processor-readable storage medium communicatively coupled to the processor and which stores processor-executable virtual content control instructions, and wherein:
determining a region of interest in a field of view of a user of the wearable heads-up display includes executing the processor-executable virtual content control instructions by the processor to cause the wearable heads-up display to determine the region of interest in the field of view of the user;
projecting, by the projector, virtual content with a first quality level with respect to a first display parameter in the region of interest of the field of view of the user includes executing the processor-executable virtual content control instructions by the processor to cause the projector to project virtual content with the first quality level with respect to the first display parameter in the region of interest of the field of view of the user; and
projecting, by the projector, virtual content with a second quality level with respect to the first display parameter in regions of the field of view of the user that are outside of the region of interest includes executing the processor-executable virtual content control instructions by the processor to cause the projector to project virtual content with the second quality level with respect to the first display parameter in regions of the field of view of the user that are outside of the region of interest.
